(19) United States
(12) Patent Application Publication
(10) Pub. No.: US 2002/0120472 A1
(43) Pub. Date: Aug. 29, 2002

(54) System and method for integration of health care records

(76) Inventors: Carl D. Dvorak, Madison, WI (US); Khiang Seow, Madison, WI (US); Daniel Bormann, Waunakee, WI (US); Steve Larsen, Madison, WI (US); Cliff Michalski, McFarland, WI (US); Andrew Ma, Madison, WI (US); Mark Lipsky, Waunakee, WI (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/007,066

(22) Filed: Dec. 5, 2001

Related U.S. Application Data
(60) Provisional application No. 60/258,008, filed on Dec. 22, 2000.

(51) Int. Cl. G06F 17/60

(52) U.S. Cl. 705/3

(57) ABSTRACT

In accordance with the invention, a patient-centered integrated health care record is provided including information related to health care delivery for a patient, and information related to health care delivery management for the patient. The integrated health care record may be used with a health care system to facilitate management of and to provide health care for patients. The health care delivery information and the health care delivery management information for patients may be stored within the UPR as patient records, with one patient record per patient. The information may be stored as formatted data, links to formatted data, or as selections from a list. In one embodiment, audit functionality is provided, where contact with data records is recorded as an audit trail. In another embodiment, security functionality is provided, controlling access to the integrated health care record. In another embodiment, a lock manager is provided, controlling write access to the integrated health care record.

### CROSS-REFERENCE TO RELATED APPLICATIONS

This application claims priority to U.S. Provisional Patent Application Serial No. 60/258008, entitled “Patient-Centered Data-Level Integration in Computerized Functionality to Support the Operation and Management of Health Care,” filed Dec. 22, 2000 (attorney docket no. 29794/36697), the disclosure of which is hereby incorporated by reference.

### FIELD OF THE INVENTION

The present invention relates to health care record management, and more particularly, to a system and method for integrating health care records and facilitating access to health care records for a health care enterprise.

### BACKGROUND OF THE INVENTION

Health care enterprises provide various aspects of patient care. To provide patient care, it is necessary to maintain many types of information for patients. This information includes medical information such as allergies, current medical conditions, records of encounters with health care providers, and medical history such as immunization records, past conditions and procedures, laboratory results, family history, social history and risk factors. Health care enterprises must further maintain information regarding risk management such as payors, coverages and patient benefit information, claim history, financial information such as patient account balances and insurance balances, and patient demographic information such as patient addresses, religious contacts, emergency contacts and patient employer information.

Access to these types of information is typically provided through a variety of software applications, usually related to the type of services being provided. For example, when a patient is at a primary care physician's office for an appointment, the physician may run a medical condition/history application for accessing medical history and entering current medical conditions, including any treatments done, and tests which need to be performed on the patient. This information is stored in a patient record corresponding to the medical history/condition application. The patient is then sent to the scheduling desk, where the person in charge of scheduling tests opens a scheduling application. The required test is entered, and the test is scheduled. The required test and scheduled time are then stored in another patient record corresponding to the scheduling application. After scheduling, the patient is sent to the accountant for the office, where an accounting application (which may, for example, be part of a risk management application) is accessed for handling the billing of the patient. The billing clerk enters the treatments performed on the patient, accesses the patient insurance information, and generates a bill. The treatment, insurance and billing information is stored in a record corresponding to the patient in the accounting application.

Storing the patient information in patient records associated with the various software applications causes patient information to be duplicated multiple times, requiring storage media with greater storage capacity. In addition, maintaining various patient information across records for several different applications renders compliance with legislative requirements such as the Health Insurance Portability and Accountability Act (HIPAA) difficult. For example, the HIPAA has specific requirements for patient medical records such as maintaining data authentication for verifying data in patient records, authorization controls for controlling access to patient records, and audit controls for recording accesses/changes to patient records.

Regarding data verification, where duplicated information is entered for a patient in various software applications, the chance for errors in the data increase. When there is a conflict in the patient data corresponding to one application as compared with corresponding patient data present in another application, it is often difficult to reconcile which information is correct to verify the patient data. Regarding authentication controls, the use of multiple applications increases the difficulty for maintaining the correct security requirements for the applications, as multiple security files must be maintained. The security files for the various applications may include duplicated, and possibly conflicting data, increasing chances of providing a system user with erroneous security access to patient records. Regarding audit controls, the use of multiple software applications results in the generation of multiple audit records for each patient and/or system user. Where it is desired to know the audit trail for a particular patient record or system user, multiple audit reports must be generated. Each audit report will typically contain information duplicated in other audit reports, making it difficult and time consuming to sift through the various audit reports to locate specific audit information.

Storing patient information in patient records corresponding to various software applications limits the amount of patient information available to each application. In certain circumstances, it is desirable for the system user to access information not available in the patient record for a currently open application. In this case, another application must be opened to access such information. For example, a physician accessing a medical condition/history application may desire to access information regarding a patient's insurance to determine whether specific tests are covered by the insurance. To do this, the physician must open the accounting (or risk management) application to view the patient's insurance information.

In an effort to solve some of these problems, attempts have been made to allow applications to access the patient data records available in other applications by interfacing the patient data records from some applications with other applications. Configuring the patient data records of one application to be accessed by other applications is expensive, requiring substantial cost for providing and maintaining the interface of patient data records with various applications, and increasing processing demands on the system. Further, such configuring of the patient data records is especially difficult where the patient data record for one application is in a different format than the patient data records for other applications. In addition, where interfacing of the patient data records is finally achieved, use of the applications is significantly slowed while patient information from the patient data records are converted between formats.

The present invention is directed to overcoming one or more of the problems discussed above.

### BRIEF DESCRIPTION OF THE DRAWINGS

FIG. 1 is a graphic representation of a universal patient record in connection with a user interface and master files and a central data repository in accordance with an embodiment of the invention;

FIG. 2 is a graphic representation of a universal patient record in accordance with an embodiment of the invention;

FIG. 3 is a graphic representation of master files linked with the universal patient record of FIG. 2 in accordance with an embodiment of the invention;

FIG. 4 is a workflow diagram illustrating the functionality of the universal patient record of FIG. 2 in accordance with an embodiment of the invention;

FIG. 5 illustrates the universal patient record of FIG. 2 with associated master files of FIG. 3 as used in a suite of software in accordance with an embodiment of the invention;

FIG. 6 is a workflow diagram illustrating a data communication process for the Universal patient record of FIG. 2 in accordance with an embodiment of the invention;

FIG. 7 illustrates a detailed view of the suite of software illustrated in FIG. 5 for providing patient registration functionality;

FIG. 8 illustrates a detailed view of the suite of software illustrated in FIG. 5 for providing enterprise master person index functionality;

FIG. 9 illustrates a detailed view of the suite of software of FIG. 5 for providing inpatient admission, discharge and transfer functionality;

FIG. 10 illustrates a detailed view of the suite of software of FIG. 5 for providing patient accounting functionality;

FIG. 11 illustrates a detailed view of the suite of software of FIG. 5 for providing risk management functionality;

FIG. 12 illustrates a detailed view of the suite of software of FIG. 5 for providing inpatient clinical system functionality;

FIG. 13 illustrates a detailed view of the suite of software of FIG. 5 for providing web-based patient record functionality;

FIG. 14 illustrates a detailed view of the suite of software of FIG. 5 for providing ambulatory electronic medical record functionality;

FIG. 15 illustrates a detailed view of the suite of software of FIG. 5 for providing nurse triage/nurse call center functionality;

FIG. 16 illustrates a detailed view of the suite of software of FIG. 5 for providing enterprise scheduling functionality;

FIG. 17 illustrates a detailed view of the suite of software of FIG. 5 for providing operating room management functionality; and

FIG. 18 illustrates a graphical representation depicting the universal patient record integrating functionality at a data level in accordance with an embodiment of the invention.

### DETAILED DESCRIPTION OF THE PREFERRED EMBODIMENT

In accordance with the invention, a patient-centered integrated health care record (universal patient record (UPR)) is provided including information related to health care delivery for a patient, and information related to health care delivery management for the patient. Multiple UPRs may be provided, where each UPR includes information related to health care delivery and management of health care delivery for a particular patient. The UPR(s) is used with a health care system to facilitate management of and to provide health care for patients. The information of the UPR may be stored as formatted data, links to formatted data, or as selections from a list, further discussed below. System users have access to the UPR through one or more user interfaces in communication with the UPR.

Having the UPR which includes information for both health care delivery and health care delivery management for a patient provides a common source of data for a particular patient, on which a health care system may rely, without the need to interface multiple databases. Therefore, complicated, time consuming, and expensive configuration and data format conversion issues are avoided. Further, the UPRs common source of information facilitates integration of multiple software applications as a single software application, and reduces, if not eliminates, data duplication, thereby reducing storage space required for the UPR as compared with the multiple prior art patient records maintained for a patient. Further the reduced data duplication translates to lower operating costs associated with the entry of duplicated data by office personnel.

The UPR also facilitates compliance with legislative enactments, for example the Health Insurance Portability and Accountability Act (HIPAA). The UPR expedites authentication of data in a patient record as all data for a patient is made available. Reduced data duplication lowers the chances for conflicting data within the UPR, and the difficulty associated with determining which of the conflicting data is accurate. Additionally, using the UPR reduces the chances of multiple data records being created for a patient, where the same patient is identified with more than one patient record. In one embodiment, where audit functionality is provided, compliance with HIPAA is expedited. Because substantially all data corresponding to a patient is stored in the UPR, an audit record/trail for accesses and changes to data in the UPR may easily be provided. In another embodiment, security functionality is provided, where the UPR includes security information defining system user access. Because of the single source of security information, the chance for duplicated and potentially conflicting/erroneous security access is reduced. In another embodiment, a lock manager operates at a level between the UPR and the software functionality provided by the health care system, where the lock manager controls system user write access to the UPR. Because the lock manager operates at a level between the UPR and the software functionality, and not at the database level, assigning portions of the patient record to be access-locked and access-locking the portions of the patient record occurs more efficiently than in systems locking data at the database level.

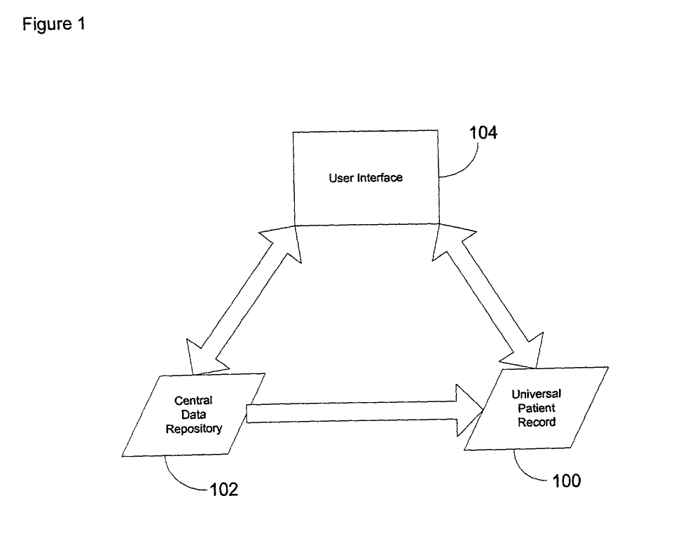

FIG. 1 illustrates the relation of a UPR 100 in communication with a central data repository 102 and a system user interface 104. The UPR 100, the central data repository 102, and the system user interface 104 work together to form a health care system, where the UPR 100 and the central data repository 102 reside on one or more storage media, for example, hard disk drives, computer diskettes, compact disks, magnetic tape, or any other storage media as would be appreciated by one skilled in the art. The UPR 100 is typically a part of the central data repository 102, and maintains substantially all patient-related data for a patient, including information related to health care delivery, and health care delivery management. The information is maintained as at least one of formatted text/data, links to formatted data, and selection(s) from a list. The UPR 100 may contain all patient-related data, or in a preferred embodiment, may include patient-specific data with non-patient-specific data residing elsewhere on the central data repository 102. The system user interface 104 may be a personal computer with corresponding display device, a handheld computing device, or any other interface capable of providing the system user access to the health care system. Typically, the health care system will include multiple UPRs, where each UPR includes health care and health care delivery management information for a corresponding patient. The one or more UPRs 100, the central data repository 102, and the system user interface 104 may be in communication via data bus lines, telephone lines, optical fiber transmission lines, wireless communication (preferably secured wireless communication), or in any other fashion as would be appreciated by one skilled in the art. Further, the storage media on which the UPR 100 and/or the central data repository 102 reside may include a single storage media, or several individual storage media in communication with one another, while still achieving the advantages of the invention.

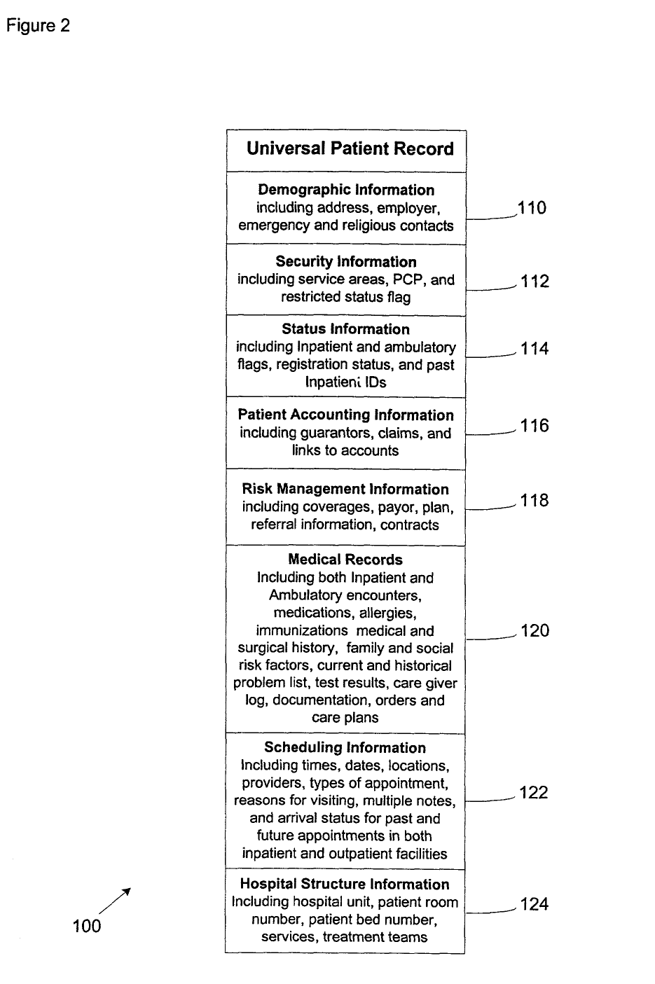

A system user is presented with a range of functionality in the user interface 104. Some of the functionality presented to the system user relates to the delivery of health care to a patient, and other of the functionality is related to health care delivery management for the patient. The UPR 100 and central data repository 102 offer a common source of data for providing the functionality to the system user. The data structure of the UPR 100 is shown in FIG. 2 in accordance with an embodiment of the invention.

The UPR 100 includes information regarding health care delivery, and information regarding health care delivery management for a particular patient. The information in the UPR 100 may include patient demographic information 110, security information 112, status information 114, patient accounting information 116, risk management information 118, medical records 120, scheduling information 122, and hospital structure information 124. Information regarding health care delivery may include medical records 120. Information regarding health care delivery management may include patient demographic information 110, security information 112, status information 114, patient accounting information 116, risk management information 118, scheduling information 122 and hospital structure information 124. As discussed above, the UPR may be one of many UPRs within a health care system, where each UPR maintains demographic, security, status, accounting, risk management, medical record, scheduling and hospital structure information for corresponding patients. As also discussed above, the data stored in each UPR may be formatted text/data, links to formatted text/data, or selections from a list of available data, and will be further discussed below.

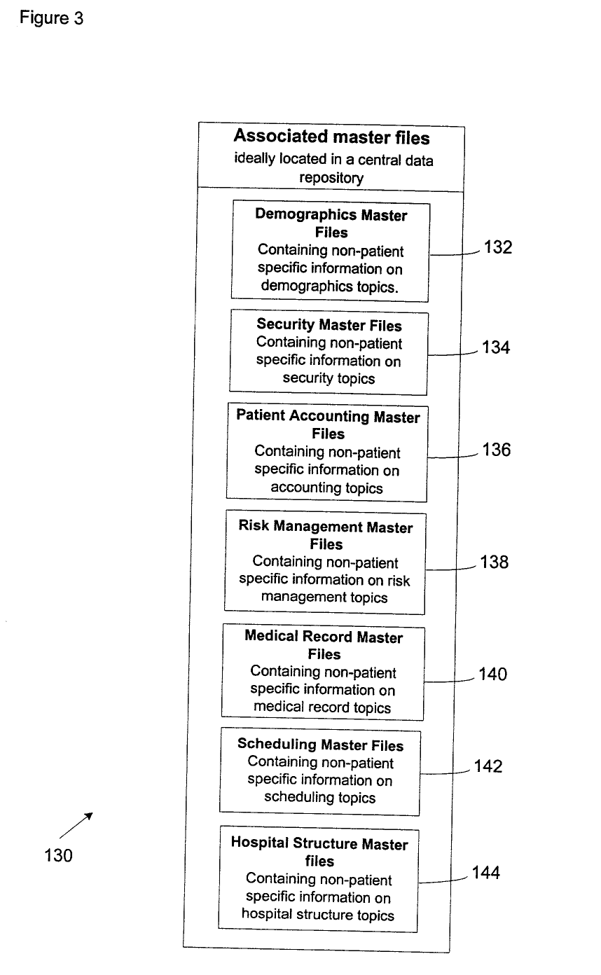

The demographic information 110 includes information such as patient address, patient employer, and patient emergency and religious contacts. The security information 112 includes information including service areas, primary care physician and restricted status flags, where the status flags may be used to control, among other things, the types of information made available to software functionality associated with the health care system by linking information to the patient record depending on the context accessing the patient record. The status information 114 includes information such as inpatient and ambulatory flags, registration status, and past inpatient identifications. The patient accounting information includes information such as charges, payments, computations, guarantors, claims and links to accounts. Patient coverages, payor and other billing information, plan, referral information and risk management contracts are included in the risk management information 118. The medical records 120 includes information related to inpatient and ambulatory encounters, medications, allergies, immunizations, medical and surgical history, family and social risk factors, test results, care giver log and documentation, orders, care plans, and a current and historical problem list. The scheduling information 122 includes information related to appointment times, dates, locations, providers, types of appointments, reasons for visiting, scheduling notes, and arrival status for past and future appointments in both inpatient and outpatient facilities. The hospital structure information 124 includes information related to the hospital unit, room number and bed number for the patient as well as services and treatment teams. The UPR includes associated files, for example, master files 130 maintained in the central data repository 102. The master files 130 are shown in FIG. 3.

The master files 130 include demographics master files 132 which include non-patient-specific information on demographics topics, security master files 134 which include non-patient-specific information on security topics, and patient accounting master files 136 which include non-patient-specific information on accounting topics. The master files 130 further include risk management master files 138 which include non-patient-specific information on risk management topics medical record master files 140 which include non-patient-specific information on medical record topics, scheduling master files 142 which include non-patient-specific information on scheduling topics, and hospital structure master files 144 which include non-patient-specific information on hospital structure. The one or more UPRs 100 of the health care system include links to records/files in corresponding master files 130, allowing patient-specific information to be stored in a manner that supports integrated features.

One example of a link to a corresponding master file would be for insurance company payor address in risk management information 118. The risk management master files 138 may include, among other information, a list of insurance company payors having corresponding addresses, where the risk management information 118 for one or more UPRs 100 includes a link to a particular selection from the list of insurance company payors of the risk management master files 138. Where the address for that particular insurance company payor changes, the new address need only be entered in the risk management master files 138 through an administrative functionality (discussed below), and not in each UPR affected by the address change, as the link from the UPR(s) to the risk management master files will ensure that the most current address information is available for the patient records.

Having the UPR 100 with associated master files 130 provides a common source of data for which a health care system may rely, without the need to interface to/with multiple databases, thereby avoiding complicated, time consuming and expensive configuration and data format conversion issues. Further, the UPR's common source of information facilitates integration of multiple software applications as a single software application, as discussed below, and reduces if not eliminates data duplication, thereby reducing storage space required for the UPR, as compared with the multiple patient records and corresponding data duplication of the prior art. Further the reduced data duplication translates to lower operating costs associated with the entry of duplicated data by office personnel. Compliance with the HIPAA is facilitated as well, as the UPR's common data source provides reliable authentication of data in a patient record as substantially all data for a patient is made available. Reduced data duplication lowers the chances for conflicting data within the UPR, and the difficulty associated with determining which conflicting data is accurate. Additionally, creation of multiple patient records for a particular patient, where the same patient is identified with more than one patient record, is reduced.

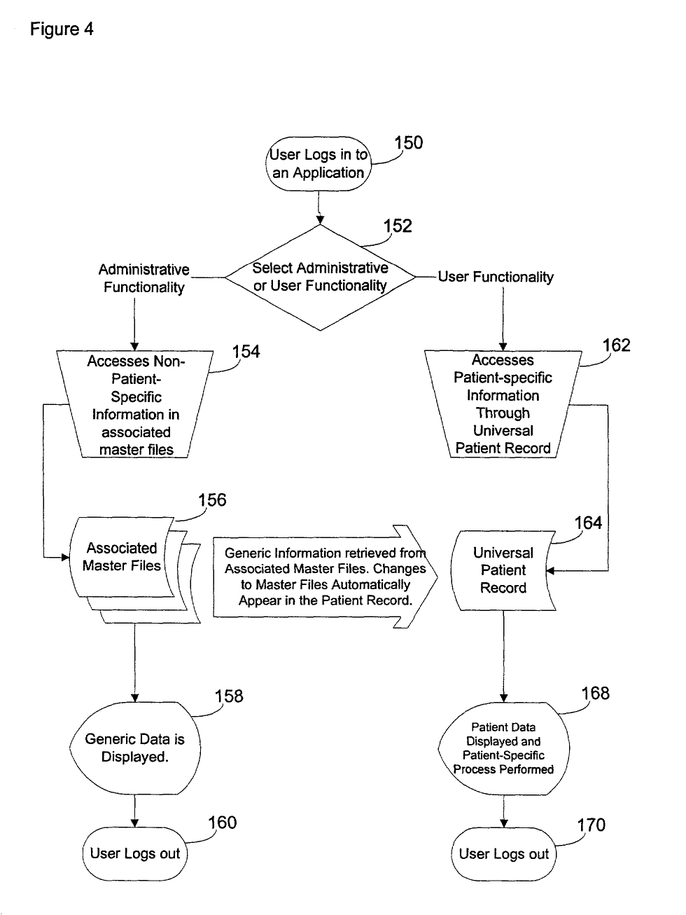

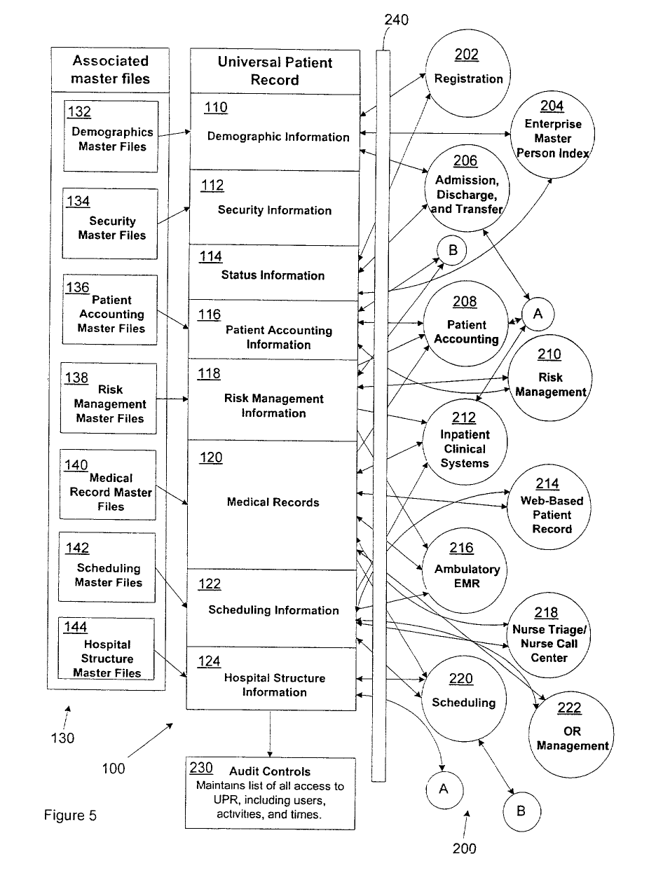

FIG. 4 illustrates a general workflow in software functionality based on the UPR 100 in accordance with an embodiment of the invention. As shown in box 150, a system user logs into an application using the user interface 104. The system user selects a given software functionality which may be a patient-specific end-user functionality, or a type of administrative functionality, box 152. Where administrative functionality is selected, access is provided to the system user for non-patient-specific information, box 154. Such non-patient-specific information is provided in the associated master files 130 of the central data repository 102. Administrative workflows provide for accessing, viewing, entering, editing or other manipulation of non-patient-specific data stored in the demographics, security, patient accounting, risk management, medical records, and scheduling master files 132, 134, 136, 138, 140 and 142, respectively, step 156. As shown in box 158, generic data is displayed, where the UPR is not directly affected. For example, patient accounting master files 136 may be altered to change a claims submission address for a particular insurance agency, as discussed above. One or more UPRs may include a link to this particular insurance provider, however, the address to the insurance provider may be updated without directly affecting and accessing each affected UPR. Updating non-patient-specific information in this manner necessitates changing the data only once, not several times for each affected patient record. Once all manipulations or other necessary accesses to the non-patient-specific information are completed, the system user logs out from the administrative application as shown in box 160.

Where the system user selects patient-specific user functionality in box 152, the patient-specific information is accessed using the UPR 100, as shown in box 162. When accessing the patient-specific information using the UPR, the UPR includes both formatted data for the particular patient, selections from lists, and links to generic information from associated master files. For example, medical history for a particular patient may be stored as formatted data in the UPR, wherein insurance billing information for a particular patient may be stored in the UPR as a link to that patient's insurance company information residing as generic information within associated master files, boxes 164, 166. Thus, changes to the associated master files are automatically accounted for in a particular UPR 100. The patient data is displayed, and patient-specific processes are performed, box 168, and when all desired access to this patient-specific information is complete, the system user logs out from the patient-specific user application, box 170. FIG. 5 illustrates a suite of software functionality relying on the UPR 100 for data level integration, in accordance with an embodiment of the invention.

FIG. 5 graphically illustrates the interaction between software functionality, generally shown at 200, and the UPR 100 and associated master files 130. Elements of FIG. 5 having the same reference numerals as elements of FIGS. 1-3 discussed above are the same and will not be discussed in detail. Each element of software functionality 200 accesses one or more portions of the UPR 100 where information in the UPR may be stored as formatted data, links to supporting data, for example, from corresponding master files 130, or as selections from a list, the list stored in either the UPR 100, associated master files 130, or any other data source (not shown, but may include, for example, an interface to a third party database) in communication with the UPR 100. FIG. 5 illustrates the role of the UPR 100 in terms of functionality, looking at which sections of the UPR 100 are used by each software functionality, and analyzes the UPR by data range, and by which applications are served by which set(s) of data. For the purpose of simplicity, FIG. 5 focuses on software functionality which provides patient-specific information, and does not include the software functionality for providing non-patient-specific functionality such as administrative actions on the non-patient-specific information.

The software functionality 200 is typically provided via the user interface 104, and may include registration 202, an enterprise master person index (EMPI) 204, admission, discharge and transfer 206, patient accounting 208, and risk management 210. The software functionality 200 may further include inpatient clinical systems 212, web-based patient record 214, ambulatory (electronic medical record) EMR 216, nurse triage/nurse call center 218, scheduling 220, and operating room (OR) management 222. The software functionality 200 may be interfaced with the UPR 100 via the access manager 240. Before discussing the role of the UPR 100 in terms of functionality and in terms of data range, a discussion of the access manager 240 is provided.

The access manager 240 controls various aspects of access between the software functionality 200 and the UPR 100. The access manager 240 typically includes a security system manager (not shown) for controlling system user access with the UPR 100, and a lock manager (not shown) for controlling system user's capabilities for writing to the UPR 100. The access manager exists at a level between the UPR 100 and the software functionality 200, and not at the data level of the UPR 100.

The lock manager includes a plurality of write tokens, where each write token controls write access to a particular portion of the UPR. Only one write token exists for writing to a particular portion(s) of a UPR. The existence of only one write token prevents multiple system users from simultaneously writing to the same portion of the particular UPR, thereby preventing corruption of that patient record. The portion of a patient record controlled by a particular write token may be set by health care system administrators, where the write token may control write access for the entire UPR, or just a portion of the UPR. Where the write token controls write access to just a portion of the UPR, additional write tokens may be provided to provide write access control for the remainder of the patient record.

Where a system user makes a write request to write information to a portion of the UPR 100 for a particular patient, the lock manager of the access manager 240 determines whether or not the write token corresponding to that portion of the UPR for the patient is available. Where the write token is available, the write token is transferred to the requesting system user, and the system user is enabled to write information to the corresponding portion of the UPR 100. However, where the write token is possessed by another system user, the lock manager generates and delivers a write token information message to the requesting system user, indicating the another system user in possession of the requested write token, an identification of the user interface for the another system user, and the time that the write token was transferred. Using write tokens in this fashion prevents multiple system users from simultaneously writing data to a particular UPR or UPR portion, thereby protecting the integrity of the patient record.

The security manager utilizes security information to control access to the UPR 100. For example, the central data repository 102 may further include an employee security data base defining the security access of various employees of the health care enterprise. The employee security data base is then used to control access of the employees to the functionalities and patient records of the health care system. Security information portion 112, which includes patient-specific security information, may further be used to limit a health care employee's access to patient records. For example, the security information portion 112 may restrict a particular employee's access to that universal patient record, may restrict access of employees based on the physical location where the patient is located (i.e., employees at a satellite clinic may not have access to patient records for patients at the main clinic), and an employee's access may be limited in other ways as would be understood by one skilled in the art.

From a functionality perspective, registration functionality 202 and admission, discharge and transfer functionality 206 allow users to view and enter/edit demographic information 110, set status information 114, and enter hospital structure information 124 in the UPR. The EMPI 204 uses this information to perform duplicate checking, for example, duplicate patient records, and other functions. The patient accounting function 208 provides entry of patient account information into the UPR, and uses medical record information 120 and hospital structure information 124 to generate new charges, patient statements, insurance claims and risk management information 118 to calculate and route the new charges. Risk management functions 210 supply and manipulate patient accounting information 116 and risk management information 118 in the UPR. Inpatient clinical system 212 (including, for example, inpatient EMR and inpatient scheduling information) uses hospital structure information 124, and both the inpatient clinical system 212 and the ambulatory EMR 216 allow entry and manipulation of medical record information 120 and reception of scheduling information 122 for display. Further, the inpatient clinical systems 212 and ambulatory EMR 216 utilize risk management information 118 for decision support features. The web-based patient record 214 allows system users to view and edit certain medical record information 120 and scheduling information 122 from the UPR. The nurse triage/nurse call center functionality 218 allows both viewing and editing of medical records information 120 and scheduling information 122 from the UPR 100. Scheduling functionality 220 allows reception of orders and other medical information 120 and hospital structure information 124 from the UPR, and provides entry of scheduling information 122. Further, scheduling functionality 220 draws on risk management information 118 and allows the entry of patient accounting information 116 and the display of registration information (for example, demographic information 110) for the patient.

From the perspective of which applications are served by which sets of data, demographic information 110 may be entered from any functionality including, for example, the registration 202 and admission 206 functionalities. The demographic information 110 is used and may be manipulated by the EMPI 204, and is also available to other functionality, as a means of identifying the patient to system users, for example, allowing any functionality requiring information regarding a patient's age, race, or gender, to retrieve the demographics information 110 from the UPR 100. The security information 112 in the UPR is created largely through internal processes, and is generally available to functionality performing security checks in determining a system user's access privileges to a particular UPR. The status information 114 is typically set using the registration 202 and admission 206 functionality. The EMPI 204 uses temporary identifications stored in a UPR and adds its own IDs to the UPR. Patient accounting information 116 is entered and edited primarily from the patient accounting functionality 208, and also from the risk management functionality 210 and scheduling functionality 220 (used, for example, in the collection of co-payments). The risk management information 118 is entered and edited through the risk management functionality 210 as well, and is used for decision support in the inpatient clinical systems 212 and ambulatory EMR 216, and for calculating charges in and routing claims to patient accounting functionality 208. The medical record information 120 is entered and edited primarily through the inpatient clinical systems 212 and ambulatory EMR 216, and also from the web-based patient record 214 and the nurse triage/nurse call center functionality 218. The medical record information 120 is utilized by patient accounting 208 to generate new claims and by scheduling functionality 220 to identify unscheduled orders for the UPR. The scheduling information 122 is entered and edited primarily through the scheduling functionality 220 and also through the web-based patient record functionality 214 and nurse triage/nurse call center functionality 218. The scheduling information 122 is additionally made available in the inpatient clinical system 212 and ambulatory EMR 216 functionalities. The hospital structure information 124 is used, entered and edited by the admission, discharge and transfer functionality 206, and further used by patient accounting 208, inpatient clinical systems 212 and scheduling 220. Audit controls 230 in communication with the UPR 100 are provided for recording all contact with the UPR 100. Any contact with the UPR 100 is recorded in an audit trail within the audit controls 230, where the system user, information accessed, and actions performed on the data are recorded. Such actions may include viewing, editing, and creation of new data, or other manipulations to or use of data in the UPR 100.

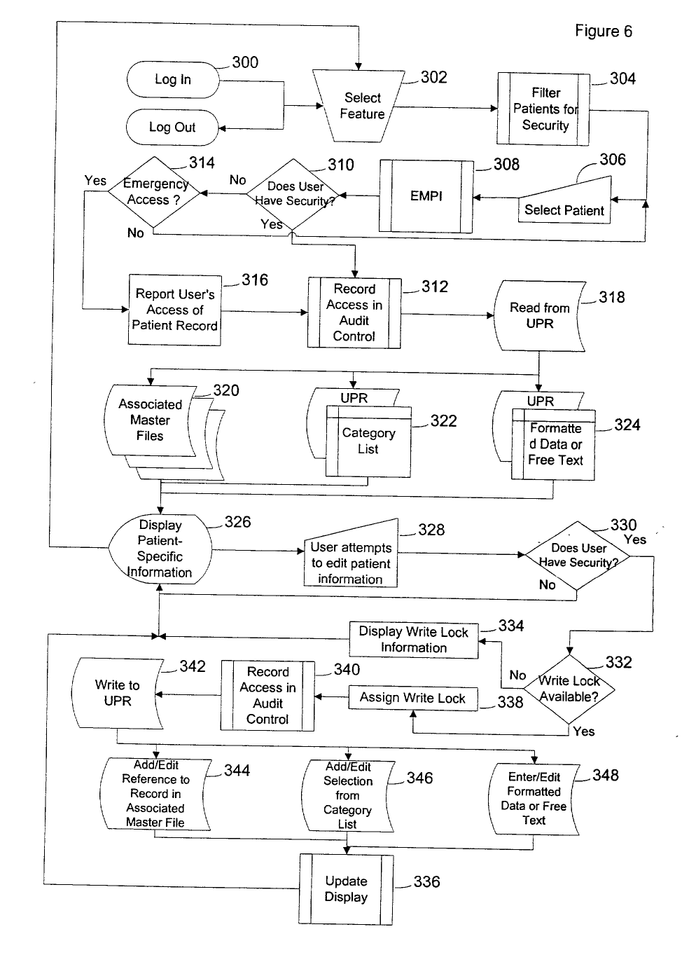

The relationship between the UPR 100 and master files 130 is also shown in FIG. 5 in accordance with an embodiment of the invention. It is shown that the demographic information 110 of the UPR 100 is supported by demographics master files 132, security information 112 is supported via the security master files 134, and the patient accounting information 116 is supported by the patient accounting master files 136. The risk management information 118 is supported by the risk management master files 138, the medical records 120 are supported by medical record master files 140, scheduling information 122 is supported by the scheduling master files 142, and hospital structure information 124 is supported by hospital structure master files 144. General and specific functionality utilizing the UPR 100 are discussed below with reference to FIGS. 6-17.

FIG. 6 illustrates a general process of system user input/output in relation to a UPR 100 in accordance with an embodiment of the invention, showing in greater detail processes involved in communicating data to and from the UPR 100. A system user logs into the health care system, using for example the user interface 104, as shown in box 300. The system user selects which feature/functionality is desired, box 302. For purposes of simplification, administrative functionality is not included in this diagram, and the selected feature box 302 is assumed to relate to some aspect of patient care, for example, software functionalities 200 discussed with respect to FIG. 5. Because substantially all patient-specific information is accessed through the UPR, a first step of selecting the feature in box 302 is to select a particular UPR for a patient. Before the patient record is made available to the system user, the health care system performs a basic security check, box 304, which filters out certain patients based on their location or relationship to the system user (for example, based on their service area, or physical location such as being located in different states). The UPR may include security information in the security information portion 112 defining security clearance for system users accessing the UPR, where a security manager (not shown) of the access manager 240 controls system user access based on the security information. In box 306, a patient is selected using for example a standard patient look-up module, based on functionality from the EMPI functionality 204, box 308.

The EMPI functionality 204 provides an index for UPRs maintained in the health care system, where the UPRs may be indexed by, for example, a patient identification. The EMPI functionality 204 is also capable of tracking patient activity across multiple physical locations or internal organization divisions. The standard patient look-up module may comprise programming within the EMPI functionality 204, where use of the standard look-up module in conjunction with the EMPI functionality 204 ensures availability of virtually all patient information to the system user.

Before the patient information is displayed, further security checks are performed by the security manager using the security information of the UPR 100, box 310. Depending on the particular functionality being used, certain patients or information for certain patients may be unavailable for access by the system user. Where the system user has sufficient security clearance for viewing the information for a particular patient, the system user is provided access to the UPR for that patient. The contact with the UPR is recorded in the audit control 230, step 312. Where the user does not have sufficient security clearance for viewing the particular patient record in box 310, the health care system may provide for emergency access to a patient's record as shown in box 314. In this circumstance, the system user's access generates an automatic message to the system user's supervisor when accessing patient information, box 316. Alternatively, a supervisor's access code may be required to access the UPR for the patient. The emergency access is then recorded in the audit control 230, as shown in box 312. As shown in box 318, information from the UPR for the particular patient is viewed. In this embodiment, the information in the UPR may be linked to a file or record in an associated master file 130, box 320, the information may be stored as a selection from a category list in the UPR 100 or master files 130, box 322, or the information may be stored directly in the UPR for the patient as formatted data or free text, box 324. For example, where the scheduling functionality 220 is being used, the required resources for scheduling an appointment are selected from an associated master file, for example the scheduling master file 142, where the type of appointment is selected from a category list stored within the scheduling master file 142. The time of the appointment may be entered directly into the UPR 100 for the patient using the scheduling functionality 220, and stored as part of the scheduling information 122 in the UPR 100.

After the patient-specific information has been gathered through the UPR, it is displayed for the system user, box 326, utilizing for example a display (not shown) of the user interface 104. Where the user desires to edit patient information, box 328, a security check is performed by the security manager of the access manager 240 to determine if the system user has security clearance to enter the information, box 330. This maybe determined utilizing security information stored for the particular system user within the UPR 100, as discussed above. Where the system user does not have proper security clearance to edit information in the UPR for the patient, the system user is limited to viewing information displayed, box 326.

However, where the system user does have security clearance to edit information in the UPR in box 330, the access manager 240 (FIG. 5) determines whether a write token is available, box 332. Where a write token for the particular portion of the UPR is not available, a write token information message is displayed to the system user including which system user is in possession of the write token, the particular user interface being used by the system user in possession of the write token, and the time that the write token was assigned, box 334. The system may continue to display patient-specific information as shown in box 326. Where the write token is available for the system user in box 332, the write token is assigned to the system user, box 338. The assignment of the write token to the system user is recorded in the audit control 230, as shown in box 340, and the system user is enabled to write to a portion of the UPR 100 corresponding to that particular write token, box 342. The system user may edit the patient record by adding or removing references from the patient record to records in associated master files, box 344, by adding or editing selections from a category list, box 346, or by entering/editing formatted data or free text within the UPR 100, box 348. Any changes to the UPR for the patient are continually recorded in the audit trail for that system user and for the UPR, by the audit controls 230. In an alternate embodiment, the assignment of the write token is not recorded by the audit control 230, but rather just changes to the UPR 100 by the system user are recorded.

Typically, the system user editing the patient information is not able to alter the information in the associated master files or category lists through the UPR, but rather is only able to alter the links to the master files. Altering and editing the associated master files is allowed within administrative functionality, discussed above. Once changes are made to the patient record, the changes are updated on the system user's display, and also updated for other system users viewing the UPR for the patient, as shown in box 336. The displays may be updated as each piece of information is altered/edited. Alternatively, any displays connected to the health care system may be updated at predetermined intervals of time, or on demand by the system user, as would be appreciated by one skilled in the art.

The lock manager of the access manager 240, operating at a level between the UPR and the software functionality, allows write tokens to be defined for portions of the patient record and allows write tokens to be assigned to system users more efficiently than in systems locking data at the database level. The audit functionality provided by Audit controls 230 facilitates compliance with the HIPAA. Because substantially all patient data is stored in the UPR, an audit record/trail for accesses and changes to data in the UPR may easily be provided. Further, the security manager of the access manager 240 reduces the chance for duplicated and potentially conflicting/erroneous security access, because the UPR provides a single source of security information for system users, further expediting compliance with the HIPAA.

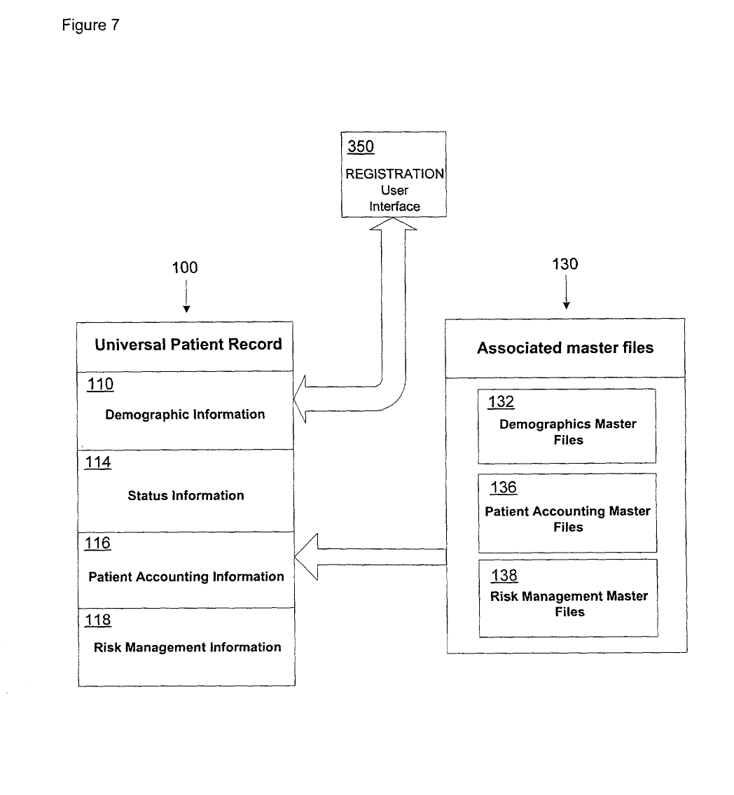

FIG. 7 illustrates a detailed view of the patient registration functionality 202 of FIG. 5 including the portions of the UPR 100 and associated master files 130 which may be used to support the registration functionality 202 in accordance with an embodiment of the invention. The registration functionality 202 is provided to a system user via a registration user interface 350 which may be part of the system user interface 104. The registration functionality 202 offers a range of data entry options for adding to the UPR for the patient. New patients may be added into the health care system, demographic information may be collected and stored via the demographic information portion 110 and corresponding demographic master files 132, and various status information may be set in the status information portion 114. Further, patient accounting and risk management information may be set in the patient accounting information portions 116 and corresponding accounting master files 136, and in the risk management information portion 118 and corresponding risk management master files 138. The status information 114 is typically stored as patient-specific data in the UPR, where the other information entered into the patient record is typically supported by the associated master files, for example as data links to the master files, or as selections from lists residing within the master files.

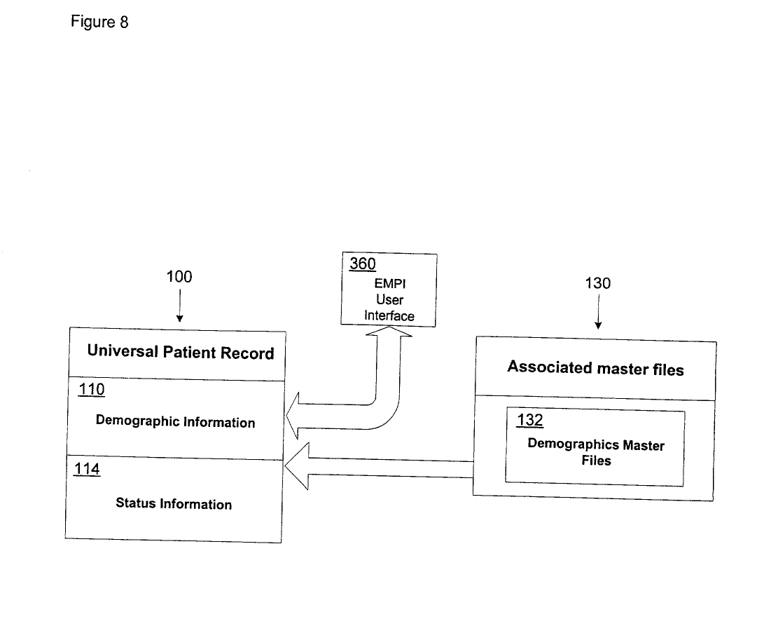

FIG. 8 illustrates a detailed view of the EMPI functionality 204 in accordance with an embodiment of the invention. The EMPI functionality 204 is provided via an EMPI user interface 360 which may be part of the system user interface 104. The EMPI functionality 204 identifies patients and performs duplicate checking based on a range of demographic information. For example, upon entry of a patient name and/or address, the EMPI functionality 204 may search through other UPRs within the health care system for other patients having identical names and/or addresses. UPRs for other patients having, for example, the same name and/or address are displayed, and may be selected by the system user. In this way, creation of duplicate UPRs within the health care system may be avoided. Further, status information such as a previously used patient identification for a particular patient may be used to locate a complete set of information for the particular patient. While the status items for the patient are typically stored in the UPR, associated master files such as the demographics master files 132 typically support the demographic information 110 entered in the patient record. Other data may be used by the EMPI functionality 204 including a patient's age, sex, social security information, e-mail address, alias, etc.

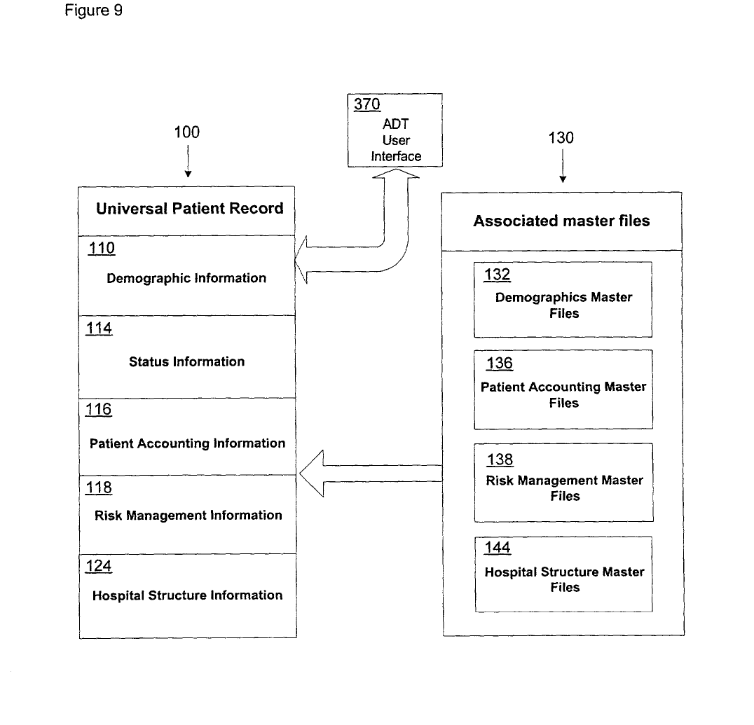

FIG. 9 illustrates a detailed view of inpatient admission, discharge and transfer functionality 206 in accordance with an embodiment of the invention. The admission, discharge and transfer functionality 206 is provided to a system user via an admission, discharge and transfer user interface 370, which may be part of the system user interface 104. The admission, discharge and transfer functionality provides options to add UPRs for particular patients. Additionally, the admission, discharge and transfer functionality may be used to assign patients to a specific hospital unit, room and bed, collect demographics information, and set various status items, for example whether a patient is being seen in an inpatient or ambulatory context. System users may also enter accounting and risk management information for the patient. The status items are stored in the status information portion 114 of the UPR, whereas the other information entered into the patient record is typically stored in the demographic information portion 110 and supporting demographics master files 132, patient accounting information portion 116 and corresponding supporting patient accounting master files 136, risk management information portion 118 and supporting corresponding risk management master files 138, and hospital structure information 124 and corresponding master files 144.

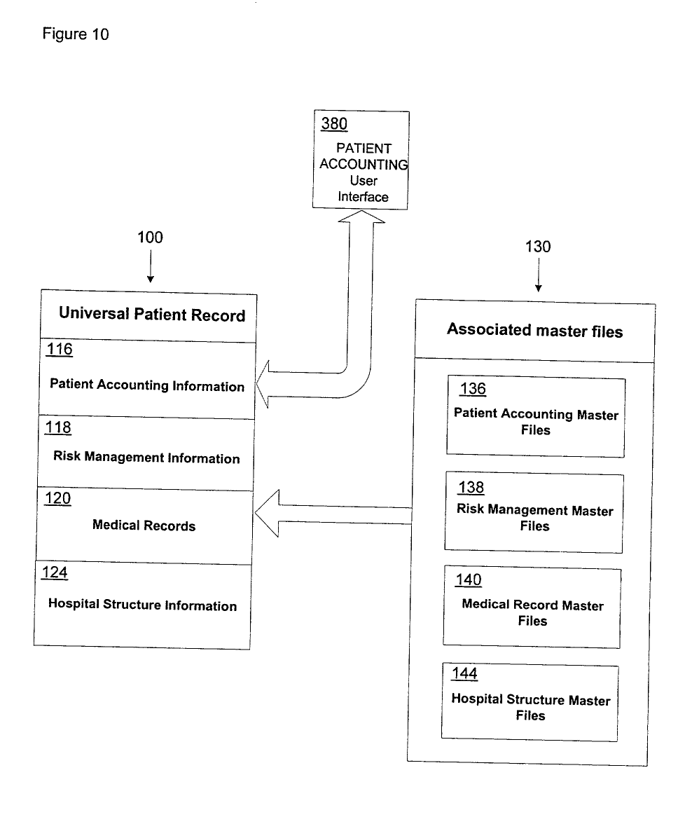

FIG. 10 illustrates a detailed view of the patient accounting functionality 208 in accordance with an embodiment of the invention. The patient accounting functionality 208 is provided to a system user via a patient accounting user interface 380, which may be incorporated in the system user interface 104. The patient accounting functionality offers a variety of patient-specific accounting options, based on information in the UPR 100 for a patient. The patient accounting functionality 208 allows managing patient accounts, and allows for performing a range of charge entry and computations based on medical records information 120, and hospital structure information 124. The accounting functionality 208 utilizes risk management information 118 in routing the charges, for example to insurance companies. The information entered into the patient record through the accounting functionality is typically stored in patient accounting information portion 116 supported by patient accounting master files 136, risk management information portion 118 supported by risk management master files 138, medical records information portion 120 supported by medical records master files 140, hospital structure information 124 supported by hospital structure master files 144, and demographic information 110 supported by demographic master files 132.

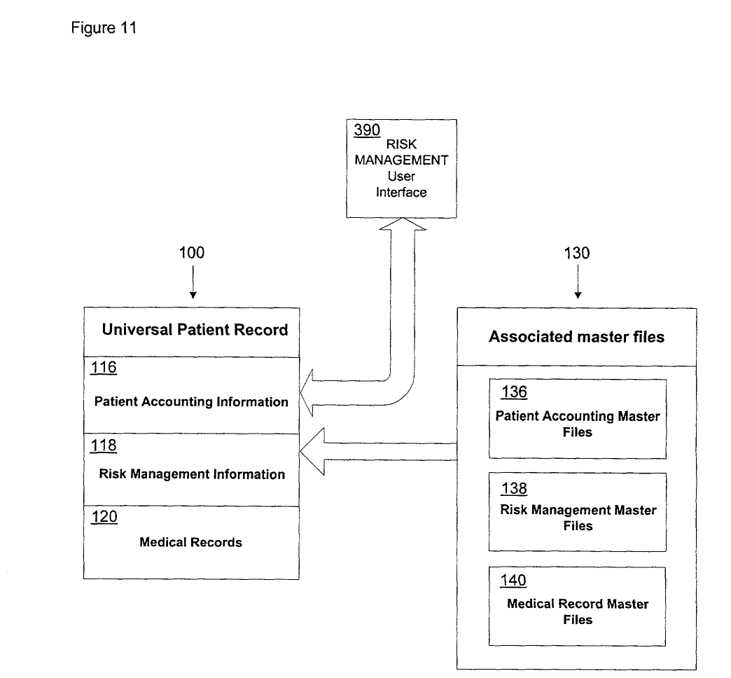

FIG. 11 illustrates a detailed view of the risk management functionality 210 in accordance with an embodiment of the invention. The risk management functionality 210 is provided to a system user via a risk management user interface 390, which may be part of the system user interface 104. The risk management functionality 210 provides a range of information and entry options to create managed care coverage policies and assign patients to them. In addition to entering coverage information, system users may coordinate the system's interaction with patient accounting functionality. The risk management information and corresponding features are typically supported by the patient accounting information portion 116 with supporting patient accounting master files 136, risk management information portion 118 and corresponding risk management master files 138, and medical records information portion 120 and corresponding medical records master files 140.

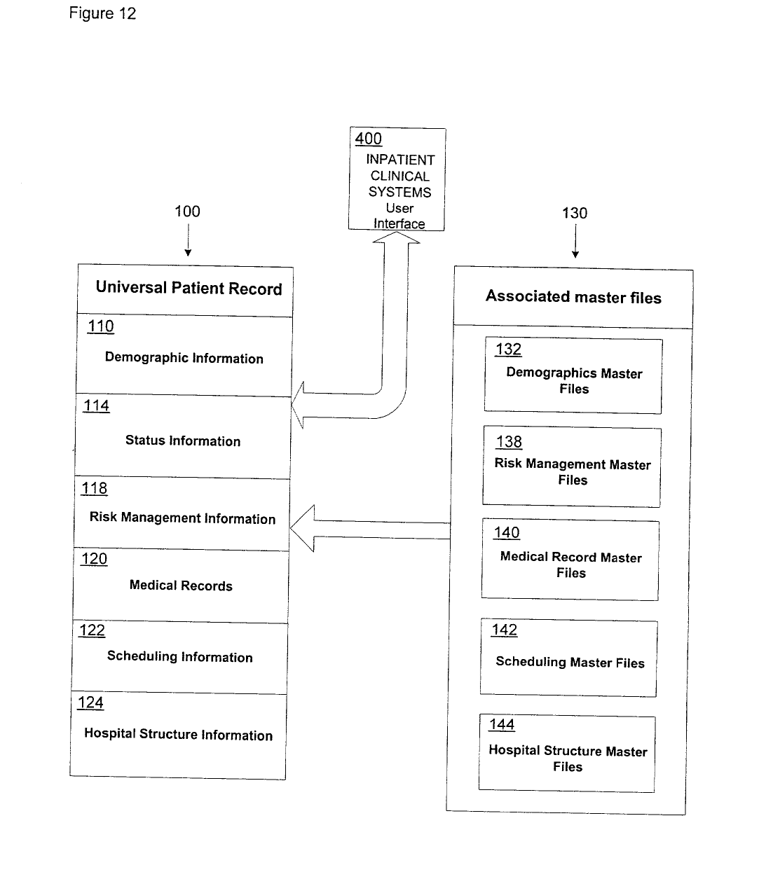

FIG. 12 illustrates a detailed view of an inpatient clinical system functionality 212 in accordance with an embodiment of the invention. The inpatient EMR functionality 212 is provided to a system user via an inpatient clinical system user interface 400 which may be part of the system user interface 104. Through the inpatient clinical system functionality 212, a range of information and entry options are provided to record medical information based on interactions with patients, for example in an inpatient context. Additionally, the inpatient clinical system functionality 212 provides scheduling and hospital census information to health care providers, and draws on and allows updating of hospital structure information 124 (supported by hospital structure master files 144). The inpatient clinical system functionality also features decision support based on medical records portion 120 with corresponding medical record master files 140, risk management portion 118 with supporting risk management master files 138, and demographic information portion 110 with corresponding demographic master files 132. Other information portions, for example, status information portions 114 provide further information to the system user via the inpatient clinical systems user interface 400.

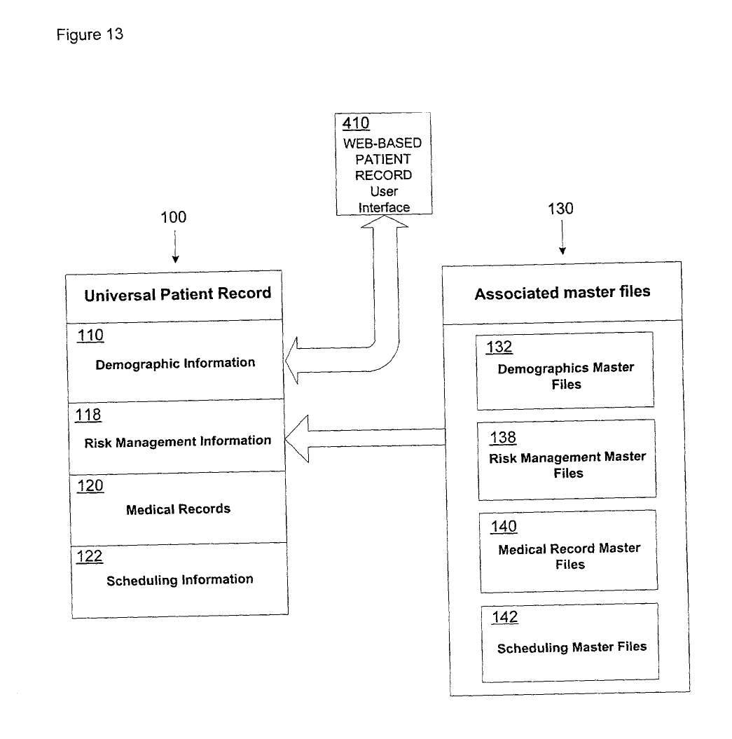

FIG. 13 illustrates a detailed view of the web-based patient record functionality 214 in accordance with an embodiment of the invention. The web-based patient record functionality 214 is provided to a system user via a web-based UPR user interface 410 which may be integrated within the system user interface 104. The web-based patient record functionality 214 provides a system user Internet access to the UPR 100, granting system users a range of information entry options to record medical information based on encounters with patients. Additionally, medical information entry, scheduling information, and decision support based on medical, demographic and risk management information from the UPR 100 is provided to system users via the Internet. The information for the web-based patient record functionality 214 is typically provided via the medical records portion 120 and corresponding supporting medical record master files 140, scheduling information portion 122 with supporting scheduling master files 142, demographics information portion 110 with supporting demographics master files 132, and risk management information portion 118 with corresponding supporting risk management master files 138. Further, not shown, the Web-based patient record functionality 214 may provide hospital structure information (e.g., hospital unit, room number and bed number) for a patient, where the hospital structure information 124 is supported by hospital structure master files 144.

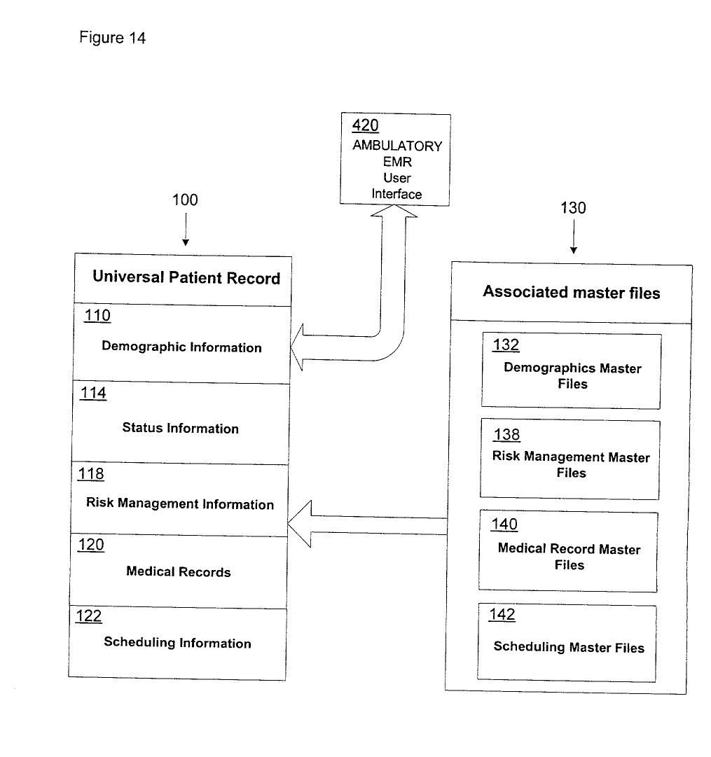

FIG. 14 illustrates a detailed view of the ambulatory EMR functionality 216 in accordance with an embodiment of the invention. The ambulatory EMR functionality 216 is provided to a system user via an ambulatory EMR user interface 420, which may be integrated within the system user interface 104. The ambulatory EMR functionality 216 provides information entry options to record medical information based on encounters with the patients, for example, in an emergency room context. Additionally, an ambulatory EMR functionality 216 provides scheduling information to providers, and features decision support based on medical, demographic, and risk management information. The ambulatory EMR functionality 216 is typically supported via demographic information portion 110 with corresponding demographic master files 132, status information portion 114, risk management information portion 118 with corresponding risk management master files 138, medical records portion 120 with corresponding medical record master files 140, and scheduling information portion 122 with corresponding scheduling master files 142.

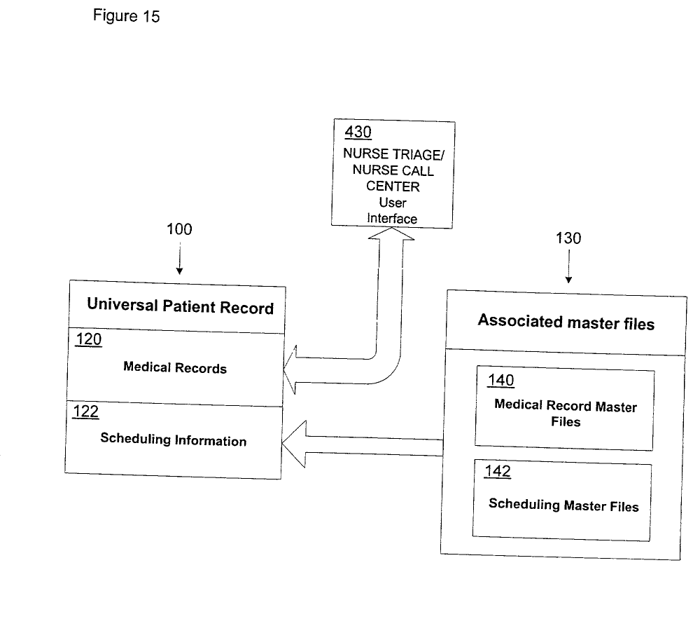

FIG. 15 illustrates a detailed view of the nurse triage/nurse call center functionality 218 in accordance with an embodiment of the invention. The nurse triage/nurse call center functionality 218 is provided to a system user via a nurse triage/nurse call center user interface 430, which may be part of the system user interface 104 The nurse triage/nurse call center functionality 218 offers a range of options to view existing medical information and log new medical information during telephone encounters with patients. Additionally, the call center functionality 218 may provide customer relationship management (i.e., customer service). Further, system users may view a patient's scheduled appointments and reschedule or create new appointments as needed. The nurse triage/nurse call center functionality 218 is typically supported by medical records portion 120 and corresponding medical record master files 140, and scheduling information portion 122 with corresponding scheduling master files 142.

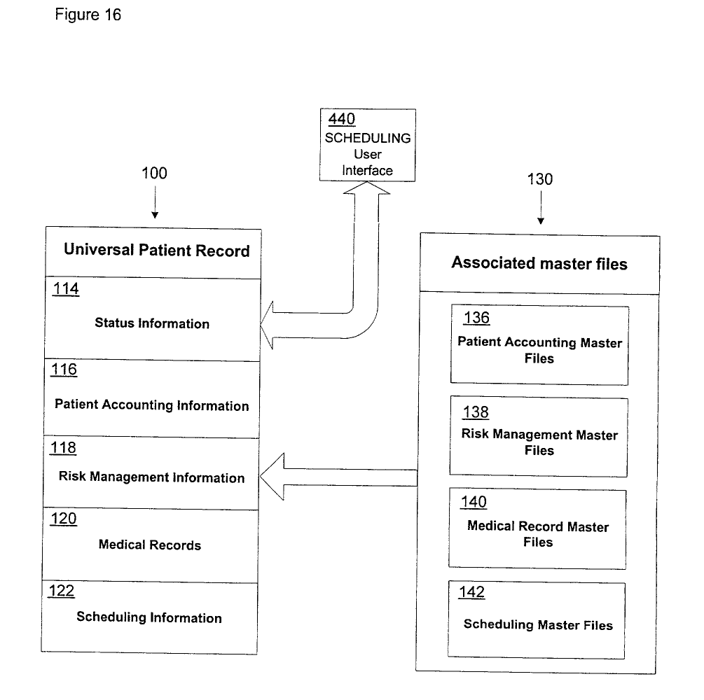

FIG. 16 illustrates a detailed view of the enterprise scheduling functionality 220 in accordance with an embodiment of the invention. The enterprise scheduling functionality 220 is provided to a system user via a scheduling user interface 440, which may be part of the system user interface 104. The enterprise scheduling functionality 220 provides system users options to create and modify appointments for patients. Further, providers may place orders for tests and procedures, which are scheduled, based on medical information in the UPR 100. The enterprise scheduling functionality 220 is typically supported by the medical records information portion 120 and corresponding medical record master files 140, scheduling information portion 122 with corresponding scheduling master files 142, status information 114, patient accounting information 116 and corresponding patient accounting master files 136, and risk management information 118 and corresponding risk management master files 138.

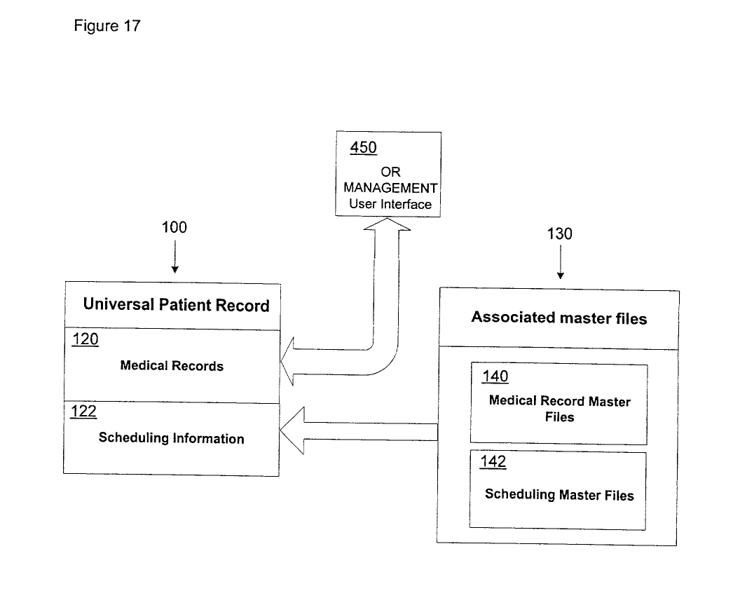

FIG. 17 illustrates a detailed view of the OR management functionality 222 in accordance with an embodiment of the invention. The OR management functionality 222 is provided to a system user via an OR management user interface 450, which may be part of the system user interface 104. The OR management functionality 222 provides system users the ability to record progress of and enter notes for OR procedures, and maintain a record regarding consumption of OR supplies. The OR management functionality 222 is typically supported by the medical records information portion 120 and corresponding medical records master files 140, and scheduling information portion 122 with corresponding scheduling master files 142.

The software functionality 200 has been described above as being part of the suite of software of FIG. 5. However, not all of the software functionalities 200 need be provided within the suite of software. Thus, the functionalities represented in FIGS. 6-17 may operate as stand-alone functionalities interfacing with the UPR 100, or may operate in conjunction (embedded) with other of the software functionalities. For example, a software suite may comprise of only the registration functionality 202 and the enterprise master person index functionality 204 operating together and in conjunction with the UPR 100. Similarly, the security manager and lock manager may be embedded with the software functionalities, or may operate in a stand-alone fashion, interfacing with the UPR 100 and associated master files 130. Additional functionalities such as home health, pharmacy, radiology, and lab systems functionalities may be added to operate with the UPR 100 where such additional functionalities are supported by various portions of the UPR 100, and associated master files 130. Where multiple functionalities are provided within the software suite, the interfaces for the functionalities may be provided by a common user interface, for example, the user interface 104 discussed above.

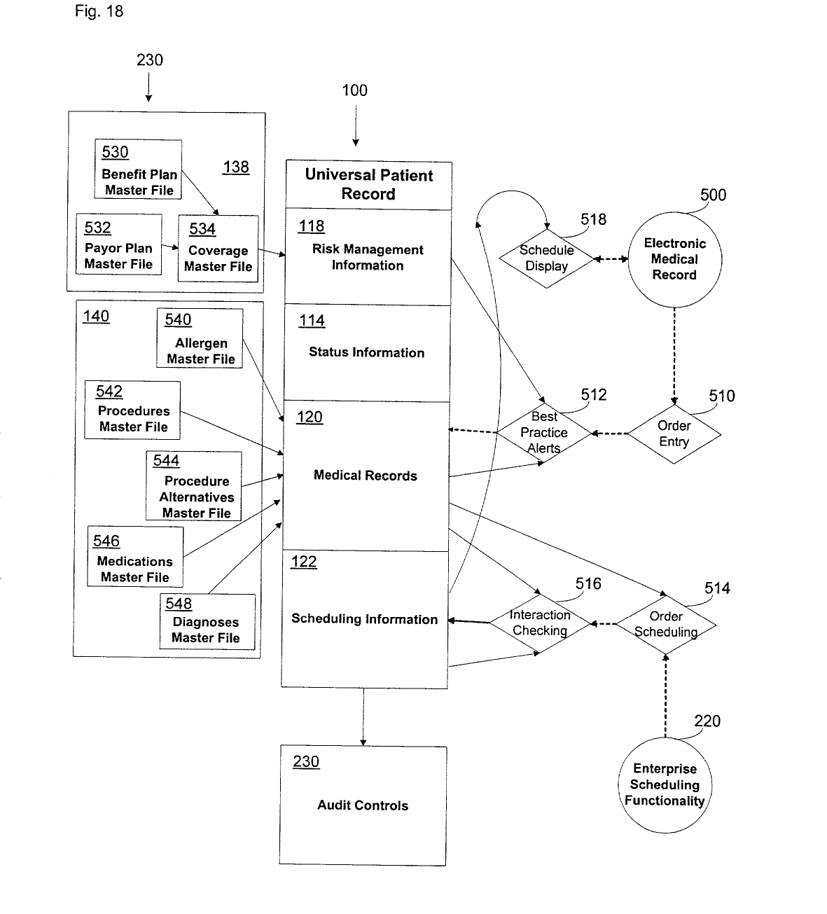

FIG. 18 illustrates a graphical representation depicting the UPR integrating functionality at a data level. Specifically, the role of the UPR 100 in the process of order entry and scheduling is illustrated, providing a specific example of how software functionality based on the UPR operates, and how workflows are based on that functionality. In FIG. 18, internal processes are depicted using solid lines, and user input/output is depicted using dashed lines.

Using a user interface 500 for an EMR, for example the inpatient clinical system or the ambulatory EMR user interfaces 400 or 420 respectively, a provider desires to place an order for a patient utilizing the UPR 100. A patient is selected, box 502, and the provider thereby gains access to information in the UPR for the selected patient. An order is entered, box 510, where the order may be for typical procedures such as medical treatments, therapy, and tests, which need to be scheduled for the patient. To accomplish the order entry, the order is sent to best practice functionality, box 512, where the order is automatically compared with coverage information from the risk management portion 111 of the UPR, and with medical record information portion 120 of the UPR. The best practice functionality may be, for example, included in the inpatient clinical system, ambulatory EMR, or scheduling functionalities, and provides for a determination of, for example, whether a particular order will be covered by the patient's insurance, or whether the patient has special health concerns which would render the order unadvisable. The UPR links the best practice alerts functionality to information concerning the patient's insurance coverages, allergies, possibly conflicting procedures, current medications, diagnoses linked to the procedure, and other relevant information, allowing the best practice functionality to alert the provider of any possible issues with the new order.

Once the order has been altered to satisfy the alert, or the alert has been cleared, the order is recorded in the UPR 100 in the medical records portion 120. Upon recording of the order, a system user via the scheduling functionality 220 accesses the UPR 100 to schedule a patient for the order, box 514, where information about the unscheduled order and information about the patient's status is made available to the scheduling functionality. The scheduler functionality selects a time to perform the procedure, and information from the UPR is used to check for conflicts, box 516. For example, scheduling information from the scheduling information portion 122 may be used to determine if other potentially conflicting appointments have already been scheduled for that patient, taking into account for example the time necessary to travel from another scheduled appointment to the present scheduled appointment. Time sensitive interactions, such as the need for fasting before drawing blood for testing may also be considered in scheduling the appointment. After the appointment is scheduled, the appointment is recorded in the UPR, for example, in the scheduling information portion 122 for the patient. Providers with whom the patient has been scheduled may look at the schedule, box 518, where information from the UPR for the patient, for example the scheduling information portion 122, is displayed, including the time, date, location, procedure, scheduling notes, and other patient-specific scheduling information.

For all interactions with patient-specific information, the software functionality typically refers to the UPR 100. At this point, the contact is recorded in an audit trail in the audit controls 230 for that particular system user and/or patient (not shown), where the system user, information accessed, and actions performed on the data are recorded. The actions may include viewing, editing, creating new data, or other manipulations to the UPR.

Further shown in FIG. 18 are master files which may be stored in the common data repository, and which support corresponding master files of the master files 130. For example, the risk management master files 138 may include master files such as benefit plan master file 530, payor master file 532, and coverage master file 534. Similarly, the medical record master files 140 may include master files including allergen master file 540, procedure master file 542, procedure alternatives master file 544, medications master file 546, and diagnosis master file 548.

The UPR provides a common source of data by which health care providers, and scheduling, accounting, registration and insurance, etc. personnel may view current health care information for a patient at any time. Thus, where a patient is transferred from one health care context, for example from an inpatient context, to another health care context such as a primary care physician (PCP), where the PCP may be at the same or a different location, the PCP is able to access current information for the patient via the UPR. Additionally, the UPR allows a patient's care to be monitored at remote locations. Further, the UPR allows software functionality to be designed to present only patient information desired by a particular health care context. For example, information for an account context need not include certain medical information such as patient allergies, family medical history, etc.

The health care system may include one or more suitable processors and storage media in communication with the processor(s) for providing the functionality described herein. The functionality may be software residing on the storage media and run on the processor. Alternatively, one or more application specific integrated circuits may be used to provide some aspects of the functionality described herein. A health care system which may utilize the UPR is described in United States patent application “A System And Method For A Seamless User Interface For An Integrated Electronic Health Care Information System,” to Dvorak et al., filed concurrently herewith, and hereby incorporated herein by reference.

As discussed above, the UPR is typically a part of the central data repository, residing on one or more storage media. The UPR may, for example, reside on the storage media as a single database record, or as multiple database records linked together. Alternatively, the UPR may be maintained in any fashion or format allowing information related to health care delivery for a patient and information related to health care delivery management to be maintained for the patient and which would achieve one or more of the advantages discussed above, as would be appreciated by one skilled in the art. For example, the patient specific information of the UPR may be present within a single database record within a database residing on the storage media, where non-patient specific information is provided in one or more separate records within the database and linked with the record providing the patient specific information.

Although the UPR has been described as relying on master files for providing supporting non-patient-specific data in a central data repository, one skilled in the art would realize that such supporting data may be included within the UPR itself. Further, the master files may be eliminated entirely, where the information in the master files is included as part of the UPR. In this case, although more storage media would be required, a common source of patient data would be provided having the advantages associated with a common data source discussed herein. Additionally, some data duplication may be acceptable in the UPR, where the UPR still provides other advantages described herein. Further, although the UPR 100 has been described as including eight portions, more or less portions may be included within the UPR 100 while still achieving the advantages discussed herein. Similarly, the associated master files 130 may also include more or less master files for supporting the UPR while still achieving the advantages discussed herein. Further, although an access manager is described herein including a lock manager and a security manager, one skilled would realize that the lock manager and security manager may be separate. The lock manager may be provided at any point in the health care system above the data level, for controlling system user write access. The security manager may be provided at any point in the health care system which allows the security manager to control system user access to the health care system and to the patient records.

The invention has been described in terms of several embodiments, including a number of features and functions. Not all features and functions are required for every embodiment of the invention, and in this manner the invention provides a UPR including information related to health care delivery for a patient, and information related to health care delivery management for the patient. The UPR provides a common source of data on which a health care system may rely, without the need to interface multiple databases. Further, the UPRs common source of information allows multiple software applications to be integrated as a single software application, and reduces if not eliminates data duplication. Further the reduced data duplication translates to lower operating costs associated with the entry of duplicated data.

The UPR also facilitates compliance with legislative enactments for example the HIPAA, making it easier to authenticate data in the patient records and eliminate duplicative patient identities. The audit functionality allows a single audit record/trail to be maintained for system users and patient records. The security functionality, using a single source of security information provided by the UPR, reduces the chance for duplicated and potentially conflicting/erroneous security access. The lock manager, operating at a level between the UPR and the software functionality allows assigning portions of the patient record to be locked and locking the portions of the patient record to occur more efficiently than in systems locking data at the database level.

The features discussed herein are intended to be illustrative of the features that may be implemented, however, such features should not be considered exhaustive of all possible features that may be implemented in a system configured in accordance with the embodiments of the invention discussed above.

We claim:

1. A patient-centered integrated health care record for a health care system, comprising:
a common data repository for storing patient-related information including information related to health care delivery for a patient, and information related to health care delivery management for the patient.

2. The integrated health care record of claim 1 wherein the common data repository includes a storage media, and patient-related information is stored as formatted data on the storage media.

3. The integrated health care record of claim 2 further comprising a database residing on the storage media, wherein the formatted data is stored in the database.

4. The integrated health care record of claim 1 wherein the common data repository includes a storage media, and patient-related information is stored as a link to formatted data on the storage media.

5. The integrated health care record of claim 4 further comprising a file stored on the storage media and including the formatted data, wherein the link is an address link to the file for accessing the formatted data.

6. The integrated health care record of claim 4 further comprising a plurality of files stored on the storage media, the plurality of files including the formatted data, wherein the link is an address link to at least one of the files for accessing the formatted data.

7. The integrated health care record of claim 1 wherein the common data repository includes a storage media, and wherein patient-related information is provided as elements of a category list, and patient-related information is stored as a selection from the category list.

8. The integrated health care record of claim 1 wherein the common data repository includes a plurality of storage media for storing the patient-related information.

9. The integrated health care record of claim 1 wherein the common data repository includes a storage media, the storage media comprising at least one of a hard disk, a computer diskette, a compact disc, and a magnetic tape.

10. The integrated health care record of claim 1 wherein the information related to the health care delivery includes at least one of personal medical information and medical history.

11. The integrated health care record of claim 10 wherein the personal medical information includes at least one of information regarding patient allergies, current medical conditions, and encounters with health providers.

12. The integrated health care record of claim 10 wherein the medical history includes at least one of immunizations, past medical conditions, past medical procedures, laboratory results, family medical history, social history, and medical risk factors.

13. The integrated health care record of claim 1 wherein the information relating to health care delivery management includes at least one of risk management information, financial information, patient demographic information, security information, scheduling information, patient status information and hospital structure information.

14. The integrated health care record of claim 13 wherein the risk management information includes information related to at least one of payors, medical coverages, medical benefits and billing information.

15. The integrated health care record of claim 13 wherein the financial information includes at least one of account balances, charges and payments.

16. The integrated health care record of claim 13 wherein the patient demographics information includes at least one of patient address, employer information, emergency contacts, and religious contacts.

17. The integrated health care record of claim 13 wherein the security information includes at least one of service areas, primary care physician information, and restricted status flags.

18. The integrated health care record of claim 13 wherein the scheduling information includes information related to at least one of providers, types of appointment, availability of appointment, reason for visiting, future arrival status, past arrival status, and multiple notes.

19. The integrated health care record of claim 13 wherein the patient status information includes at least one of inpatient status, ambulatory status, registration status, and past patient identifications.

20. The integrated health care record of claim 13 wherein the hospital structure information includes at least one of hospital unit information, hospital room number and hospital bed number.

21. The integrated health care record of claim 1 wherein the patient-related information is stored in a common format in the common data repository.

22. The integrated health care record of claim 1 wherein the patient-related information is not duplicated on the common data repository.

23. A health care system comprising:
a patient-centered integrated health care record including information related to health care delivery for a patient, and information related to health care delivery management for the patient; and
a system user interface in communication with the integrated health care record for accessing the integrated health care record.

24. The health care system of claim 23 wherein the information related to the health care delivery includes at least one of personal medical information and medical history.

25. The health care system of claim 23 wherein the information relating to health care delivery management includes at least one of risk management information, financial information, patient demographic information, security information, scheduling information, patient status information and hospital structure information.

26. The health care system of claim 23 further comprising a lock manager in communication with the patient-centered integrated health record and the system user interface, the lock manager controlling the system users access for writing information to the patient-centered integrated health care record.

27. The health care system of claim 26 wherein the lock manager includes a write token, the possession of which enables the system user to write information to the patient-centered integrated health care record.

28. The health care system of claim 27 further comprising a plurality of system users in communication with the patient-centered integrated health care record via respective system user interfaces, and further comprising a write token information message displayed by the health care system to one system user requesting the write token for the patient-centered integrated health care record where another system user is in possession of the write token for that patient-centered integrated health care record.

29. The health care system of claim 28 wherein the write token information message includes information regarding a system user identification for the one system user in possession of the write token, a system user interface identification for the one system user, and a time that the write token was granted to the one system user.

30. The health care system of claim 27 wherein the patient-centered integrated health care record includes a plurality of accessible portions, each portion having a corresponding write token, where possession of a write token enables the system user to write information to the corresponding portion of the patient-centered integrated health care record.

31. The health care system of claim 23 further comprising a plurality of patient-centered integrated health care records, each of the patient-centered integrated health care records including information related to health care delivery and information related to health care delivery management for a corresponding patient.

32. The health care system of claim 31 wherein the plurality of patient-centered integrated health care records are indexed in the integrated health care record by a patient identification.

33. The health care system of claim 23 wherein the patient-centered integrated health care record resides on storage media.

34. The health care system of claim 33 wherein the storage media includes at least one of a hard disk, a computer diskette, a compact disc, and a magnetic tape.

35. The health care system of claim 23 further comprising a plurality of system users and corresponding system user interfaces, wherein more than one system user has access to the patient-centered integrated health care record at a given instant in time.

36. The health care system of claim 35 wherein information changed in the integrated data record by one system user is substantially instantaneously available to other system users accessing the patient-centered integrated health care record.

37. The health care system of claim 35 wherein information changed in the patient-centered integrated health care record by one system user is available to other system users accessing the patient-centered integrated health care record upon refreshing of the other user's corresponding system user interface.

38. The health care system of claim 23 further comprising a security system in communication with the patient-centered integrated health care record and the system user interface for restricting the system user's access to the patient-centered integrated health care record.

39. The health care system of claim 38 wherein the patient-centered integrated health care record includes security information related to the system user, where the security system restricts the system user's access to the patient-centered integrated health care record based on the security information.

40. The health care system of claim 39 further comprising an emergency access system in communication with the security system and the system user interface for providing the system user with emergency access to the patient-centered integrated health care record.

41. The health care system of claim 23 further comprising an audit system in communication with the integrated health care record and the system user interface for maintaining information relating to accesses of the patient-centered integrated health care record by the system user.

42. The health care system of claim 41 wherein the information relating to access of the patient-centered integrated health care record includes at least one of an access time of, a portion accessed of, and activities performed on the patient-centered integrated health care record.

43. The health care system of claim 23 further comprising at least one software functionality for interfacing with the patient-centered integrated health care record, the at least one software functionality including at least one of registration, admission, discharge and transfer, accounting, risk management, inpatient clinical system, ambulatory EMR, web-based access, triage/call center, scheduling and OR management functionalities.

44. The method of claim 43 further comprising a plurality of patient-centered integrated health care records, each of the patient-centered integrated health care records including information related to health care delivery and information related to health care delivery management for a corresponding patient.

45. The health care system of claim 44 wherein at least one software functionality includes duplicate patient-centered integrated health care record prevention functionality.

46. The health care system of claim 45 wherein the duplicate patient-centered integrated health care record prevention functionality is performed using at least one of patient name, address, identification number, age, gender, social security information, e-mail address and alias.

47. A method for providing health care comprising:
storing information related to health care delivery for a patient, and information related to health care delivery management for the patient in a patient-centered integrated health care record; and
providing access to the integrated health care record for a system user via a system user interface.

48. The method of claim 47 wherein the storing of information related to the health care delivery includes storing at least one of personal medical information and medical history.

49. The method of claim 47 wherein the storing of information relating to health care delivery management includes storing at least one of risk management information, financial information, patient demographic information, security information, scheduling information, patient status information and hospital structure information.

50. The method of claim 47 further comprising controlling the system user's access for writing information to the patient-centered integrated health care record using a lock manager.

51. The method of claim 50 wherein the lock manager includes a write token, and further comprising transferring the write token to the system user thereby enabling the system user to write information to the patient-centered integrated health care record.

52. The method of claim 51 wherein a plurality of system users are provided access to the patient-centered integrated health care record via respective system user interfaces, one of the system users possessing the write token for the patient-centered integrated health care record, and another of the system users requesting the write token for the patient-centered integrated health care record, and further comprising
generating a write token information message, and
displaying the write token information message on the system interface of the another system user.

53. The method of claim 52 wherein the generating the write token information message includes generating the write token information message with information regarding a system user identification for the one system user in possession of the write token, a system user interface identification for the one system user, and a time that the write token was granted to the one system user.

54. The method of claim 47 wherein the storing of the information as the patient-centered integrated health care record includes storing a plurality of accessible portions of the patient-centered integrated health care record, and further comprising providing a plurality of write tokens, each write token corresponding to an accessible portion of the patient-centered integrated health care record, where each write token enables the system user to write information to the corresponding portion of the patient-centered integrated health care record.

55. The method of claim 47 wherein the storing comprises storing a plurality of patient-centered integrated health care records, each patient-centered integrated health care record including information related to health care delivery and information related to health care delivery management for a corresponding patient.

56. The method of claim 55 further comprising indexing the plurality of patient-centered integrated health care records by a patient identification.

57. The method of claim 47 wherein the storing information comprises storing information on storage media.

58. The method of claim 57 wherein the storing information on storage media includes storing information on at least one of a hard disk, a computer diskette, a compact disc, and a magnetic tape.

59. The method of claim 47 further comprising providing access to the patient-centered integrated health care record to a plurality of system users via a plurality of corresponding system user interfaces, wherein more than one system user has access to the patient-centered integrated health care record at a given instant in time.

60. The method of claim 59 further comprising updating system user interfaces for system users accessing the patient-centered integrated health care record where information corresponding to the patient-centered integrated health care record is altered.

61. The method of claim 47 further comprising restricting the system user's access to the integrated health care record using a security system.

62. The method of claim 61 further comprising providing security information in the patient-centered integrated health care record defining the system user access, wherein the restricting access is controlled by the security system based on the security information.

63. The method of claim 61 further comprising providing a system user with emergency access to the patient-centered integrated health care record using an emergency access system.

64. The method of claim 47 further comprising maintaining information relating to system user accesses of the patient-centered integrated health care record by an audit system.

65. The method of claim 64 wherein the maintaining information includes maintaining information regarding at least one of an access time of, a portion accessed of, and activities performed on the patient-centered integrated health care record by the system user.

66. The method of claim 47 further comprising providing at least one software functionality for interfacing with the patient-centered integrated health care record, where the at least one software functionality includes at least one of registration, admission, discharge and transfer, accounting, risk management, inpatient, ambulatory, web-based access, triage/call center, scheduling and OR management functionalities.

67. The method of claim 66 further comprising storing a plurality of patient-centered integrated health care records, each of the patient-centered integrated health care records including information related to health care delivery and information related to health care delivery management for a corresponding patient.

68. The method of claim 67 wherein the providing of the at least one software functionality includes providing duplicate patient-centered integrated health care record prevention functionality.

69. The method of claim 68 wherein the providing of the duplicate patient-centered integrated health care record prevention functionality includes performing duplicate prevention using at least one of patient name, address, identification number, age, gender, social security information, e-mail address and alias.
